(19) United States
(12) Patent Application Publication
(10) Pub. No.: US 2022/0404158 A1
(43) Pub. Date: Dec. 22, 2022

(54) CONTROL DEVICE, STRADDLE TYPE VEHICLE, CONTROL DEVICE OPERATION METHOD, AND STORAGE MEDIUM

(71) Applicant: HONDA MOTOR CO., LTD., Tokyo (JP)

(72) Inventor: Futoshi KOGA, Tokyo (JP)

(21) Appl. No.: 17/896,837

(22) Filed: Aug. 26, 2022

Related U.S. Application Data
(63) Continuation of application No. PCT/JP2020/014897, filed on Mar. 31, 2020.

(51) Int. Cl. G01C 21/34; G01C 21/36

(52) U.S. Cl. CPC G01C 21/3415; G01C 21/3691; G01C 21/3679

(57) ABSTRACT

A control device that controls a straddle type vehicle, comprising: a route information acquisition unit configured to acquire information on a planned travel route of the straddle type vehicle; a weather information acquisition unit configured to acquire weather information corresponding to the planned travel route; a determination unit configured to determine whether or not the planned travel route of the straddle type vehicle is affected by the weather based on the weather information; and a control unit configured to propose information on a refuge location for taking refuge from an influence of the weather when it is determined that the planned travel route is affected by the weather, wherein the control unit proposes a refuge location farther away from an affected area as information on the refuge location, based on the affected area affected by the weather.

### CROSS-REFERENCE TO RELATED APPLICATION(S)

This application is a continuation of International Patent Application No. PCT/JP2020/014897 filed on Mar. 31, 2020, the entire disclosure of which is incorporated herein by reference.

### BACKGROUND OF THE INVENTION

### Field of the Invention

The present invention relates to a control device, a straddle type vehicle, a control device operation method, and a storage medium.

### Description of the Related Art

PTL1 discloses a technology of comparing predicted values of precipitation amounts for each route and proposing an optimal alternative route.

### CITATION LIST

### Patent Literature

PTL1: Japanese Patent Application No. 2017-251545

However, in the technology of the related art, there is no proposal on how to deal with the case where the alternative route cannot be used, and there is a problem that it is difficult to eliminate a feeling of uneasiness of the driver.

The present invention has been made in view of the above problems, and an object of the present invention is to provide a technology for proposing an appropriate countermeasure to a driver when a travel route is affected by weather.

### SUMMARY OF THE INVENTION

According to one aspect of the present invention, there is provided a control device that controls a straddle type vehicle, comprising: a route information acquisition unit configured to acquire information on a planned travel route of the straddle type vehicle; a weather information acquisition unit configured to acquire weather information corresponding to the planned travel route; a determination unit configured to determine whether or not the planned travel route of the straddle type vehicle is affected by the weather based on the weather information; and a control unit configured to propose information on a refuge location for taking refuge from an influence of the weather when it is determined that the planned travel route is affected by the weather, wherein the control unit proposes a refuge location farther away from an affected area as information on the refuge location, based on the affected area affected by the weather.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is an external view including a straddle type vehicle (motorcycle) according to an embodiment of the present invention.

FIG. 2 is a block diagram of a straddle type vehicle (motorcycle) according to the embodiment of the present invention.

FIG. 3 is a flowchart illustrating a procedure of a process performed by a control device according to the embodiment of the present invention.

FIG. 4 is a flowchart illustrating a procedure of a process performed by the control device according to the embodiment of the present invention.

FIG. 5 is an explanatory diagram of a refuge location according to the embodiment of the present invention.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In addition, in the present specification, expressions such as front, rear, upper, and sides (left/right) may be used in expressions indicating relative orientations indicated with respect to a vehicle as a reference. For example, the term “front” indicates the front of the vehicle in the front-and-rear direction, and the term “upper” indicates in the height direction of the vehicle.

### Embodiment 1

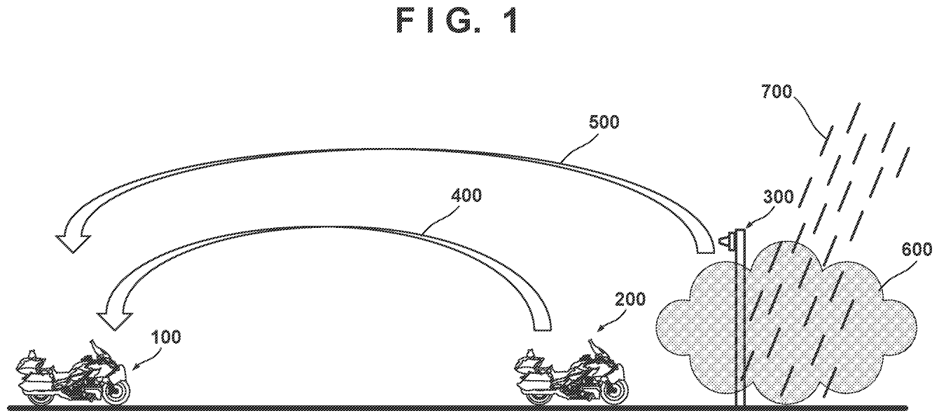

FIG. 1 is a diagram including a motorcycle which is an example of a straddle type vehicle to which the present invention is applicable. A motorcycle 100 can communicate with a preceding vehicle (such as a motorcycle 200) by vehicle-to-vehicle communication 400 to transmit and receive information. Further, the motorcycle 100 can communicate with an on-road device 300 installed on the road by road-to-vehicle communication 500 to transmit and receive information. In FIG. 1, reference numeral 600 denotes dense fog, and reference numeral 700 denotes rain.

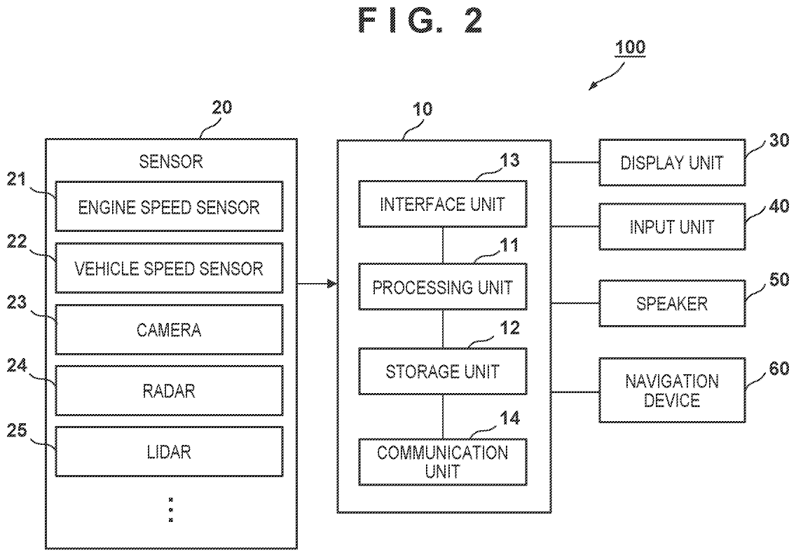

FIG. 2 is a block diagram of the motorcycle 100 according to an embodiment of the present invention. The motorcycle 100 includes a control device 10, various sensors 20, a display unit 30, an input unit 40, a speaker 50, and a navigation device 60. Note that the display unit 30, the input unit 40, and/or the speaker 50 may be included in the control device 10.

The control device 10 includes a processing unit 11 such as a CPU, a storage unit 12 such as a RAM and a ROM, an interface unit 13 that connects an external device and the processing unit 11, and a communication unit 14. The processing unit 11 executes the processing according to the present embodiment by reading and executing the program stored in the storage unit 12. The interface unit 13 is connected to the display unit 30, the input unit 40, the speaker 50, and the like. The communication unit 14 can communicate with another vehicle or an on-road device installed on the road by vehicle-to-vehicle communication or road-to-vehicle communication to transmit and receive information.

The various sensors 20 include an engine speed sensor 21, a vehicle speed sensor 22, a camera 23, a radar 24 and/or a light detection and ranging (LiDAR) 25, and the like. The engine speed sensor 21 is a sensor that detects the speed of an engine 101. The vehicle speed sensor 22 is a sensor that detects the vehicle speed of the motorcycle 100. The camera 23 is an imaging device using, for example, a CCD/CMOS image sensor. The radar 24 is, for example, a ranging device such as a millimeter wave radar. Further, the LiDAR 25 is, for example, a ranging device such as a laser radar. These are disposed at positions where surroundings information of the motorcycle 100 can be detected, for example, on the front side, the rear side, the upper side, and/or the sides of the vehicle.

The display unit 30 presents information to the driver by displaying various types of information. The input unit 40 is, for example, an operator, and receives inputs of various types of information based on an operation by the driver. The speaker 50 notifies various types of information processed by the control device 10 by voice.

The navigation device 60 can receive an input of information such as a departure place, a destination, and a transit point, and can generate a planned travel route based on the received information and present the planned travel route to the driver.

<Processing>

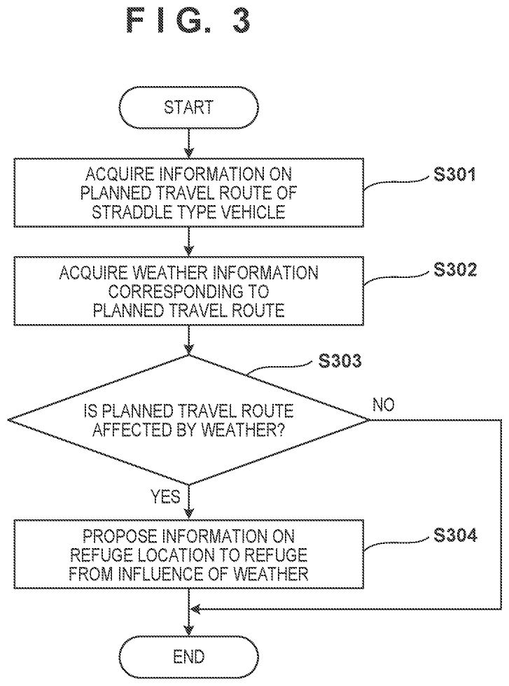

FIG. 3 is a flowchart illustrating a procedure of a process performed by the control device 10 according to the present embodiment. This processing is performed by the processing unit 11 of the control device 10 reading and executing the program stored in the storage unit 12.

[Step S301]

In step S301, the processing unit 11 acquires information on the planned travel route of the straddle type vehicle (motorcycle 100) via the communication unit 14. For example, information on a route generated by the navigation device 60 is acquired as a planned travel route.

[Step S302]

In step S302, the processing unit 11 acquires weather information corresponding to the planned travel route acquired in step S301 via the communication unit 14. For example, the weather information may be acquired from, for example, a medium (weather forecast or the like) that distributes weather information through the Internet. Alternatively, when the road is wet, rain is recognized, or dense fog is recognized by analyzing imaging information captured by a camera of a preceding vehicle (for example, the motorcycle 200 in FIG. 1), information on rain and information on dense fog may be received from the preceding vehicle via the vehicle-to-vehicle communication 400. Furthermore, weather information around the on-road device 300 present on the planned travel route may be received from the on-road device 300 by road-to-vehicle communication 500 to acquire the weather information.

[Step S303]

In step S303, the processing unit 11 determines whether or not the planned travel route is affected by the weather. Then, in a case where it is determined that there is an influence of the weather, the process proceeds to step S304. On the other hand, when it is determined that there is no influence of the weather, the process proceeds to step S305.

Specifically, it is possible to calculate the degree of influence indicating the degree of influence of the weather on the planned travel route and to determine that the planned travel route is affected by the weather when the degree of influence satisfies a predetermined condition. For example, in the planned travel route, for example, when dense fog or rain is observed or predicted at the current or a future planned travel time, it can be determined that the route is affected by the weather. It is possible to determine that the route is affected by the weather, for example, when a predetermined precipitation amount (for example, X mm per hour) or more of rain is measured or predicted. In this case, the precipitation amount corresponds to the degree of influence. Further, regarding dense fog, when a dense fog warning is issued as weather information, or when dense fog is determined by the preceding vehicle or the on-road device 300 and such information is received, it is possible to determine that the route is affected by the weather. Alternatively, when the visible distance is equal to or less than a predetermined value, the degree of influence may satisfy a predetermined condition.

Note that, in the present embodiment, the description will be given using dense fog or rain as an example. However, the case of being affected by weather is not limited to these examples, and other weather conditions, for example, lightning, snow, hail, sleet, or the like may be used.

[Step S304]

In step S304, the processing unit 11 proposes information on a refuge location at which the straddle type vehicle (motorcycle 100) can take refuge from the influence of the weather. The proposal is made by, for example, displaying information on the display unit 30 or voice notification through the speaker 50. Here, the refuge location is, for example, a commercial facility allowing keeping out of the wind and rain, for example, a restaurant, a service area, or the like. Information on the refuge location present along the planned travel route is proposed. Accordingly, the series of processes illustrated in FIG. 3 is ended.

As described above, in the present embodiment, when the planned travel route of the straddle type vehicle (motorcycle 100) is affected by the weather (for example, rain or dense fog), the information on the avoidance point for avoiding the influence is proposed.

As a result, the driver recognizes that there is a possibility of being affected by the weather, and can avoid the influence of the weather by moving to the refuge location in advance. Therefore, even when there is no detour route that can avoid the influence of the weather, countermeasures can be taken, and the feeling of uneasiness of the driver can be reduced.

### Embodiment 2

In Embodiment 1, an example has been described in which a refuge location at which the influence of the weather can be avoided is proposed when the planned travel route is affected by the weather. On the other hand, in the present embodiment, an example will be described in which an appropriate countermeasure is proposed according to a situation while a detour route is calculated. Since the device configuration and the like are similar to those of Embodiment 1, the description thereof will be omitted.

<Processing>

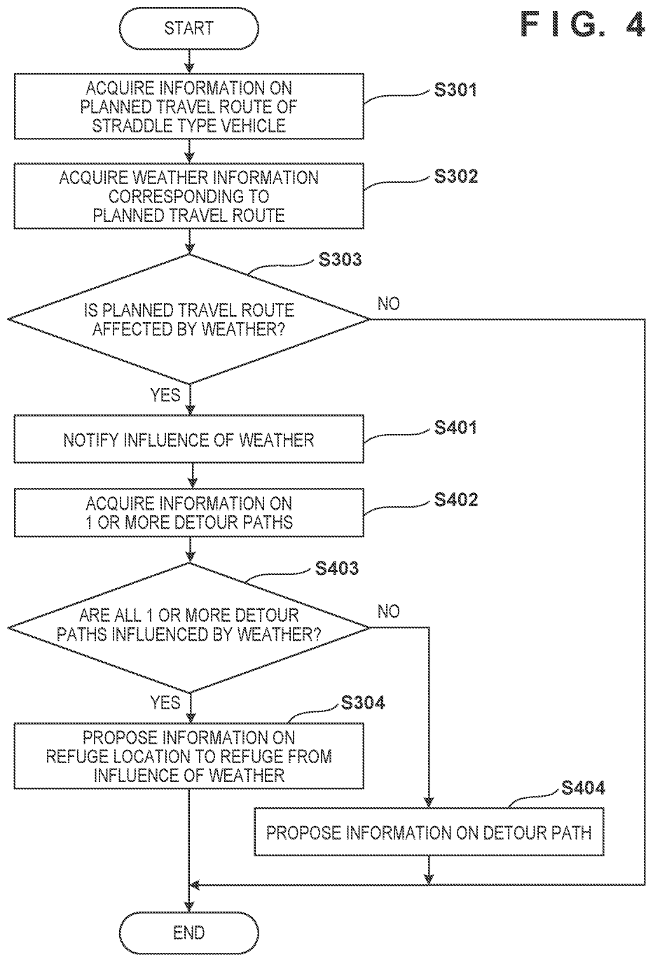

FIG. 4 is a flowchart illustrating a procedure of a process performed by the control device 10 according to the present embodiment. This processing is performed by the processing unit 11 of the control device 10 reading and executing the program stored in the storage unit 12. In addition, the same steps as those described in FIG. 3 are denoted by the same reference numerals, and the description thereof will be omitted.

[Step S401]

In step S401, the processing unit 11 notifies information (for example, an alert) indicating that the planned travel route is affected by the weather. The notification method may be performed, for example, by displaying information on the display unit 30, or may be guided by voice through the speaker 50, or both methods may be combined with each other.

[Step S402]

In step S402, the processing unit 11 acquires information on one or more detour routes. The detour route may be calculated by, for example, the navigation device 80, and information may be acquired from the navigation device 80. Alternatively, the processing unit 11 may acquire the map information from the navigation device 80, and the processing unit 11 may directly calculate the detour route.

[Step S403]

In step S403, the processing unit 11 determines whether or not all of the one or more detour routes calculated in step S402 are affected by the weather. The determination method is similar to that in step S303. When it is determined that all detour routes are affected, the process proceeds to step S304. On the other hand, when it is determined that not all of the detour routes are affected, the process proceeds to step S404.

[Step S404]

In step S404, the processing unit 11 proposes information on a detour route that is not affected by the weather. The proposal is made by, for example, displaying information on the display unit 30 or voice notification through the speaker 50. Accordingly, the series of processes illustrated in FIG. 4 is ended.

As described above, in the present embodiment, when the planned travel route is affected by the weather, information on one or more detour routes is acquired, when all the planned travel routes are affected by the weather, a refuge location is proposed, and when there is a detour route that is not affected by the weather, the detour route is proposed.

As a result, in a case where it is desired to arrive at the destination on a time-priority basis, it is possible to arrive at the destination as early as possible using the detour route without wasting time by taking refuge to the refuge location.

### Modification Examples

All of the steps described in the above-described embodiments are not necessarily required for realizing the present invention, and some of the steps may be excluded from the flow, or the order of processing can be changed in any manner. For example, the processing in step S401 in FIG. 4 may be performed after the step of acquiring a detour route in step S402.

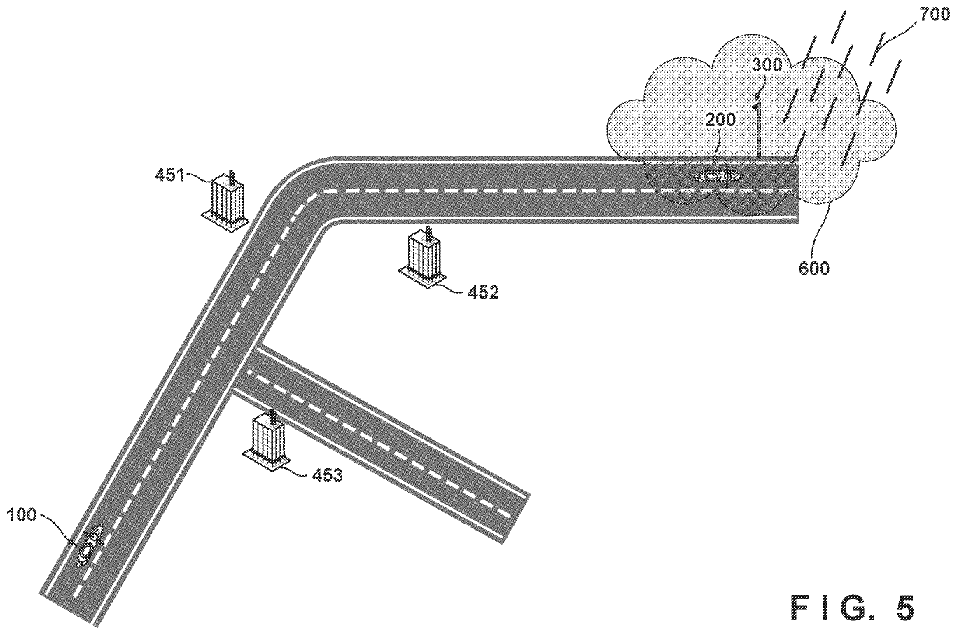

In addition, when there are a plurality of refuge locations, control may be performed to propose an optimal refuge location. For example, FIG. 5 is an explanatory diagram of a refuge location according to the embodiment of the present invention.

A case where the dense fog 600 is formed on the planned travel route of the straddle type vehicle (motorcycle 100) or the rain 700 falls is considered. In the illustrated example, three refuge locations 451, 452, and 453 (for example, commercial facilities) are assumed to be extracted.

At this time, for example, a refuge location close to the traveling lane of the straddle type vehicle may be preferentially proposed as the information on the refuge location. In this case, the refuge location to be proposed preferentially is the refuge location 451 close to the left side of the traveling lane (left lane) of the motorcycle 100. As a result, it is not necessary to cross the opposite lane at the time of taking refuge, and thus, it is possible to easily move to the refuge location.

Furthermore, for example, a refuge location farther away from the affected area may be proposed as the information on the refuge location based on the affected area affected by the weather. In this case, an area where dense fog 600 and rain 700 exist may be extracted as an affected area, and a refuge location 453 farthest from the affected area may be preferentially set as a refuge location to be proposed. Note that, regardless of the road, a case where the straight distance between the affected area (for example, the center thereof) and the refuge location is the farthest may be adopted, or a case where the travel distance along the road is the farthest may be adopted. Accordingly, it is possible to promptly take refuge to the refuge location before being affected by the weather.

In addition, when the destination of the straddle type vehicle is ahead of the position affected by the weather, control may be performed so as not to propose the information on the refuge location. When the user can arrive at the destination earlier, it is not necessary to propose a refuge location, and thus it is possible to prevent unnecessary proposal.

Note that, in each of the above embodiments, the case where the planned travel route is determined in advance has been described as an example. However, each of the above-described embodiments can also be applied to a case where free driving is performed in which a destination is not determined. In that case, for example, it may be estimated that the vehicle travels straight along the current travel route without turning right or left, and this may be acquired as the planned travel route.

Note that, in each of the above-described embodiments, the motorcycle 100 has been described as an example, but the present invention is not limited to the motorcycle. For example, the present invention is also applicable to other vehicles such as a four-wheeled vehicle.

### Other Embodiments

In addition, a program for achieving one or more functions that have been described in each of the embodiments is supplied to a system or apparatus through a network or a storage medium, and one or more processors in a computer of such a system or apparatus are capable of reading and executing the program. The present invention is also achievable by such an aspect.

The invention is not limited to the foregoing embodiments, and various variations/changes are possible within the spirit of the invention.

### Summary of Embodiments

A control device according to a first aspect is a control device (for example, 10) that controls a straddle type vehicle (for example, 100), including: route information acquisition means (for example, 11) for acquiring information on a planned travel route of the straddle type vehicle; weather information acquisition means (for example, 11) for acquiring weather information corresponding to the planned travel route; determination means (for example, 11) for determining whether or not the planned travel route of the straddle type vehicle is affected by weather based on the weather information; and control means (for example, 11) for proposing information on a refuge location (for example, 451, 452, 453) for taking refuge from an influence of the weather when it is determined that the planned travel route is affected by the weather.

As a result, the driver recognizes that there is a possibility of being affected by the weather, and can avoid the influence of the weather by moving to the refuge location in advance. Therefore, even when there is no detour route that can avoid the influence of the weather, countermeasures can be taken, and the feeling of uneasiness of the driver can be reduced.

In the control device according to a second aspect, the determination means determines that the planned travel route is affected by the weather when the weather of the planned travel route is a predetermined weather.

As a result, it is possible to propose a refuge location only in a case of specific weather.

In the control device according to a third aspect, the determination means calculates a degree of influence of the weather on the planned travel route of the straddle type vehicle, and determines that the planned travel route is affected by the weather when the degree of influence satisfies a predetermined condition.

As a result, it is possible to prevent the proposal of the refuge location even when the influence is small (for example, light rain). Therefore, the driver can propose the refuge location when necessary.

In the control device according to a fourth aspect, the predetermined weather is rain or dense fog.

Accordingly, it is possible to propose a refuge location in the case of rain or dense fog.

In the control device according to a fifth aspect, the determination means determines that the weather is rain when a precipitation amount is equal to or greater than a predetermined value.

Accordingly, it is possible to prevent the proposal of the refuge location in the case of light rain.

In the control device according to a sixth aspect, the determination means determines that the weather is dense fog when a visible distance is equal to or less than a predetermined distance.

As a result, it is possible to prevent the proposal of a refuge location when the field of view is sufficiently open and the driving is not hindered.

In the control device according to a seventh aspect, the control means does not propose information on the refuge location when a destination of the straddle type vehicle is ahead of a position affected by the weather.

As a result, it is possible to prevent the proposal of the refuge location in a situation where the proposal is unnecessary.

In the control device according to an eighth aspect, the determination means further determines whether or not one or more detour routes are affected by the weather, and the control means proposes information on the refuge location when it is determined that the one or more detour routes are affected by the weather.

As a result, not only the planned travel route but also the detour route can be proposed as information on the refuge location only when the routes are affected by the weather.

In the control device according to a ninth aspect, when it is determined that the planned travel route is affected by the weather and there is a detour route determined not to be affected by the weather, the control means proposes information on the detour route without proposing information on the refuge location.

Accordingly, it is possible to select traveling on a safe detour route when it is not desired to waste time by taking refuge to the refuge location.

In the control device according to a tenth aspect, when there are a plurality of refuge locations, the control means preferentially proposes a refuge location close to a traveling lane of the straddle type vehicle as information on the refuge location.

As a result, it is possible to eliminate the trouble of crossing the opposite lane and moving to the refuge location on the opposite side, and it is possible to enter the refuge location to which it is easy to move (for example, turn left in the case of traveling on the left side) from the traveling lane.

In the control device according to an eleventh aspect, the control means proposes a refuge location farther away from an affected area as information on the refuge location, based on the affected area affected by the weather.

Accordingly, it is possible to promptly take refuge to the refuge location before being affected by the weather.

In the control device according to a twelfth aspect, notification unit configured to notifying information indicating that the planned travel route is affected by the weather when it is determined that the planned travel route is affected by the weather, is further provided, and the control means proposes information on the refuge location after the notification by the notification means.

As a result, the driver can recognize influence of the weather at an early stage, the information on the refuge location is proposed after the recognition, and thus the driver can easily understand the reason why the information of the refuge location is proposed.

In the control device according to a thirteenth aspect, the refuge location includes a restaurant or a service area.

As a result, when the influence of the weather is predicted, it is possible to take refuge to a restaurant or a service area in advance.

According to a fourteenth aspect, there is provided a straddle type vehicle including: the control device according to any one of the first to thirteenth aspects.

Accordingly, the process of the vehicle control device is achievable on the straddle type vehicle.

According to a fifteenth aspect, there is provided a control device operation method which is a method for operating a control device (for example, 10) that controls a straddle type vehicle (for example, 100), the method including: a route information acquisition step (for example, S301) of acquiring information on a planned travel route of the straddle type vehicle; a weather information acquisition step (for example, S302) of acquiring weather information corresponding to the planned travel route; a determination step (for example, S303) of determining whether or not the planned travel route of the straddle type vehicle is affected by the weather based on the weather information; and a control step (for example, S304) of proposing information on a refuge location for taking refuge from an influence of the weather when it is determined that the planned travel route is affected by the weather.

As a result, the driver recognizes that there is a possibility of being affected by the weather, and can avoid the influence of the weather by moving to the refuge location in advance. Therefore, even when there is no detour route that can avoid the influence of the weather, countermeasures can be taken, and the feeling of uneasiness of the driver can be reduced.

According to a sixteenth aspect, there is provided a program for causing a computer to function as the control device according to any one of the first to thirteenth aspects.

Accordingly, the process of the control device is achievable by the computer.

According to the present invention, it is possible to propose an appropriate countermeasure to a driver when a travel route is affected by weather.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A control device that controls a straddle type vehicle, comprising:
a route information acquisition unit configured to acquire information on a planned travel route of the straddle type vehicle;
a weather information acquisition unit configured to acquire weather information corresponding to the planned travel route;
a determination unit configured to determine whether or not the planned travel route of the straddle type vehicle is affected by the weather based on the weather information; and
a control unit configured to propose information on a refuge location for taking refuge from an influence of the weather when it is determined that the planned travel route is affected by the weather,
wherein the control unit proposes a refuge location farther away from an affected area as information on the refuge location, based on the affected area affected by the weather.

2. The control device according to claim 1, wherein the determination unit determines that the planned travel route is affected by the weather when the weather of the planned travel route is a predetermined weather.

3. The control device according to claim 2, wherein the determination unit calculates a degree of influence of the weather on the planned travel route of the straddle type vehicle, and determines that the planned travel route is affected by the weather when the degree of influence satisfies a predetermined condition.

4. The control device according to claim 2, wherein the predetermined weather is rain or dense fog.

5. The control device according to claim 2, wherein the determination unit determines that the weather is rain when a precipitation amount is equal to or greater than a predetermined value.

6. The control device according to claim 2, wherein the determination unit determines that the weather is dense fog when a visible distance is equal to or less than a predetermined distance.

7. The control device according to claim 1, wherein the control unit does not propose information on the refuge location when a destination of the straddle type vehicle is ahead of a position affected by the weather.

8. The control device according to claim 1, wherein
the determination unit further determines whether or not one or more detour routes are affected by the weather, and
the control unit proposes information on the refuge location when it is determined that the one or more detour routes are affected by the weather.

9. The control device according to claim 8, wherein, when it is determined that the planned travel route is affected by the weather and there is a detour route determined not to be affected by the weather, the control unit proposes information on the detour route without proposing information on the refuge location.

10. The control device according to claim 1, wherein, when there are a plurality of refuge locations, the control unit preferentially proposes a refuge location close to a traveling lane of the straddle type vehicle as information on the refuge location.

11. The control device according to claim 1, further comprising:
a notification unit configured to notify information indicating that the planned travel route is affected by the weather when it is determined that the planned travel route is affected by the weather, wherein
the control unit proposes information on the refuge location after the notification by the notification unit.

12. The control device according to claim 1, wherein the refuge location includes a restaurant or a service area.

13. A straddle type vehicle comprising: the control device according to claim 1.

14. A control device operation method for operating a control device that controls a straddle type vehicle, the method comprising:
acquiring information on a planned travel route of the straddle type vehicle;
acquiring weather information corresponding to the planned travel route;
determining whether or not the planned travel route of the straddle type vehicle is affected by the weather based on the weather information; and
proposing information on a refuge location for taking refuge from an influence of the weather when it is determined that the planned travel route is affected by the weather,
wherein in the proposing, a refuge location farther away from an affected area is proposed as information on the refuge location, based on the affected area affected by the weather.

15. A storage medium storing a computer program for causing a computer to execute a control device operation method for operating a control device that controls a straddle type vehicle, the method comprising:
acquiring information on a planned travel route of the straddle type vehicle;
acquiring weather information corresponding to the planned travel route;
determining whether or not the planned travel route of the straddle type vehicle is affected by the weather based on the weather information; and
proposing information on a refuge location for taking refuge from an influence of the weather when it is determined that the planned travel route is affected by the weather,
wherein in the proposing, a refuge location farther away from an affected area is proposed as information on the refuge location, based on the affected area affected by the weather.
